(19) United States
(12) Patent Application Publication
(10) Pub. No.: US 2018/0165337 A1
(43) Pub. Date: Jun. 14, 2018

(54) System for Extracting Data from a Database in a User Selected Format and Related Methods and Computer Program Products

(71) Applicant: CA, INC., New York, NY (US)

(72) Inventor: Robin Hopper, Prague (CZ)

(73) Assignee: CA, INC., New York, NY (US)

(21) Appl. No.: 15/376,836

(22) Filed: Dec. 13, 2016

(51) Int. Cl. G06F 17/30

(52) U.S. Cl. CPC G06F 17/30569; G06F 17/30448; G06F 17/30477

(57) ABSTRACT

A method includes performing, by a host system processor: detecting a first query of a database, detecting a first relation that is generated responsive to the first query of the database, the first relation comprising a record having a plurality of fields, each of the plurality of fields having a format associated therewith, receiving user input that changes the format associated with one of the plurality of fields from a first format to a second format, generating a second query for the database based on the user input, performing the second query of the database, generating a second relation responsive to the second query of the database, the second relation comprising a plurality of records, each of the plurality of records comprising the plurality of fields, and communicating the second relation to a client device application. One of the plurality of fields in each of the plurality of records has the second format.

### BACKGROUND

The present disclosure relates to computer systems, and, in particular, to methods, systems, and computer program products for managing information in a computer database.

Computer database management systems (DBMS) may provide utilities for extracting portions of data that are stored in a database for use by other applications or devices. For example, DB2 is a relational database management system (RDBMS) that provides a utility called UNLOAD. The UNLOAD utility copies data from one or more source objects, such as a table, and outputs the copied data into a format that can be specified by the user through the command line or query used execute the operation. It can be difficult, however, for a user to determine the correct syntax and/or options to use in the command line and/or query to extract the data in the format that the user desires. This may result in multiple invocations of the UNLOAD utility as the user attempts to construct a command line and/or query with the correct syntax/options, which can waste processor time and/or memory if, for example, the output file(s) in the undesired format(s) are not promptly deleted.

### SUMMARY

In some embodiments of the inventive subject matter, a method comprises, performing by a host system processor: detecting a first query of a database, detecting a first relation that is generated responsive to the first query of the database, the first relation comprising a record having a plurality of fields, each of the plurality of fields having a format associated therewith, receiving user input that changes the format associated with one of the plurality of fields from a first format to a second format, generating a second query for the database based on the user input, performing the second query of the database, generating a second relation responsive to the second query of the database, the second relation comprising a plurality of records, each of the plurality of records comprising the plurality of fields, and communicating the second relation to a client device application. One of the plurality of fields in each of the plurality of records has the second format.

In other embodiments of the inventive subject matter, a system comprises a processor and a memory coupled to the processor and comprising computer readable program code embodied in the memory that is executable by the processor to perform: detecting a first query of a database, modifying the first query of the database to generate a modified first query for the database, performing the modified first query of the database, detecting a first relation that is generated responsive to the modified first query of the database, the first relation comprising a record having a plurality of fields, each of the plurality of fields having a format associated therewith, receiving user input that changes the format associated with one of the plurality of fields from a first format to a second format, the second format being used in a client device application, generating a second query for the database based on the user input, performing the second query of the database, generating a second relation responsive to the second query of the database, the second relation comprising a plurality of records, each of the plurality of records comprising the plurality of fields, and communicating the second relation to the client device application. One of the plurality of fields in each of the plurality of records has the second format.

In further embodiments of the inventive subject matter, a computer program product comprises a tangible computer readable storage medium comprising computer readable program code embodied in the medium that is executable by a processor to perform: detecting a first query of a database, detecting a first relation that is generated responsive to the first query of the database, the first relation comprising a record having a plurality of fields, each of the plurality of fields having a format associated therewith, receiving user input that changes the format associated with one of the plurality of fields from a first format to a second format, generating a second query for the database based on the user input, performing the second query of the database, generating a second relation responsive to the second query of the database, the second relation comprising a plurality of records, each of the plurality of records comprising the plurality of fields, and communicating the second relation to a client device application. One of the plurality of fields in each of the plurality of records has the second format and the first relation consumes less memory than the second relation.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including a database management system server for extracting data from a database in a user selected format in accordance with some embodiments of the inventive subject matter;

FIG. 2 illustrates a data processing system that may be used to implement the database management system server of FIG. 1 in accordance with some embodiments of the inventive subject matter;

FIG. 3 is a block diagram that illustrates a software/hardware architecture for use in an a database management system server for extracting data from a database in a user selected format in accordance with some embodiments of the inventive subject matter;

FIG. 4 is a flowchart diagram that illustrates operations for extracting data from a database in a user selected format in accordance with some embodiments of the inventive subject matter;

FIG. 5A is a block diagram that illustrates a first relation generated responsive to a database query in accordance with some embodiments of the inventive subject matter;

FIG. 5B is a block diagram that illustrates a modified first relation generated responsive to user input in accordance with some embodiments of the inventive subject matter; and

FIG. 5C is a block diagram that illustrates a second relation that is generated based on the data format differences between the first relation and the modified first relation in accordance with some embodiments of the inventive subject matter.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it is not limited to, a hardware element, firmware component, and/or software component. A data processing system may be configured with one or more data processing facilities.

Embodiments of the inventive subject matter are described herein in the context of extracting data from a relational database, such as a DB2 database using the UNLOAD utility. It will be understood that embodiments of the inventive subject matter are not limited in their application to a relational database model as other database models, such as, but not limited to a flat database model, a hierarchical database model, a network database model, an object-relational database model, and a star schema database model may also be used.

Some embodiments of the inventive subject matter stem from a realization that when extracting data from a database on a host system for use by an application, for example, on another device or system, it can be difficult to generate a command line and/or query that includes the proper syntax and/or options to format the extracted data in a manner that is suitable for destination application. A user may have to consult technical manuals to determine how to construct the database command line and/or query, which may be time consuming and potentially difficult to understand if the user is not experienced performing transactions with the database. Because of the difficulty a user may have in constructing a command line and/or query that extracts the data from the database in a desired format, numerous extractions may be attempted with the resulting extracted data having undesired formats. This may waste processor time and/or memory if the undesired data extractions are not deleted in a timely manner In some cases, a user may give up trying to extract the data in a desired format and instead use another tool to edit that data that was extracted to correct any undesirable formatting.

According to some embodiments of the inventive subject matter, a first query for extracting a copy of data from a database, such as an invocation of the UNLOAD utility for a DB2 database, may be detected along with a first relation that is generated in response to the query. This first relation may have one or more records that each have a plurality of fields and each of the fields may have a format associated therewith. An output file editor may provide a visual interface to allow a user to change the formats for one or more of the fields in the records in the first relation to desired formats. These desired formats may be based on the types of formats that are compatible with a client application on another device or system, for example. An output file comparator may determine what format changes a user makes to the first relation and may generate a second query for extracting data from the database based on those format changes. The second query may be a command line and/or a query with the proper syntax and options for extracting the copy of the data from the database with the data values formatted according to the user's preferences. Thus, embodiments of the inventive subject matter may alleviate a user from the need to understand the details of how to construct command lines and/or queries for extracting data from a database where the data values are formatted according to the user's preferences. The second query may be performed on the database and a second relation may be generated having one or more records with the fields in the records having associated formats that encompass the format changes made by the user. The second relation may be communicated to a client device or system for further processing by an application. In some embodiments of the inventive subject matter, the first query may be intercepted and modified so that that the number of records in the first relation is reduced to a number that is sufficient for a user to make the desired field format changes. This may reduce the processor time spent in extracting the data for the first relation along with the amount of memory consumed by the first relation (relative to a relation obtained by the unmodified first query) as many of these records are unnecessary inasmuch as the first relation is used solely for the purposes of verifying and/or changing the formats associated with one or more fields. Once the format changes have been made by the user, the first relation may be automatically deleted so as to reduce the impact on the host system's memory.

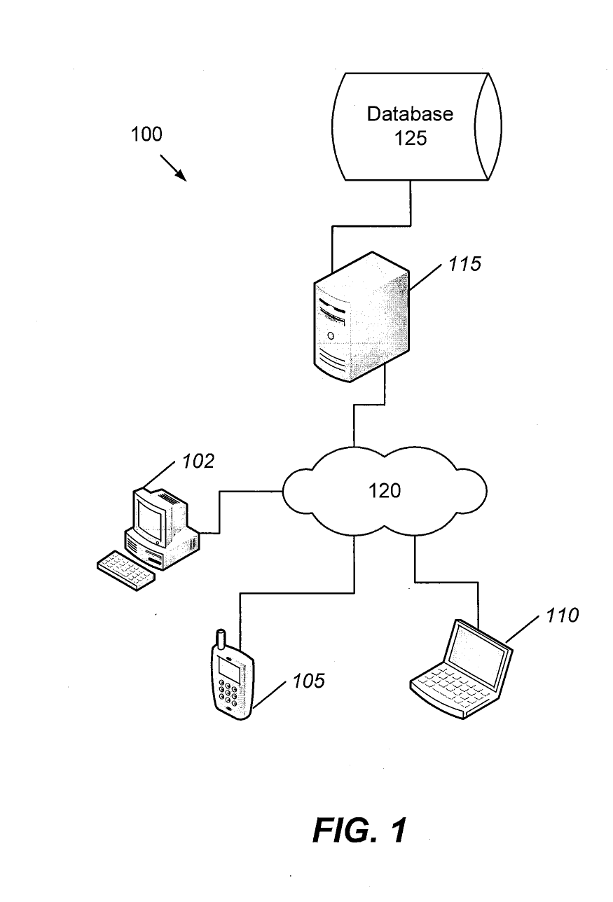

Referring to FIG. 1, a communication network including a database management system server for extracting data from a database in a user selected format, in accordance with some embodiments of the inventive subject matter, comprises client devices 102, 105, and 110 that are coupled to a host database management system server 115 via a network 120. The network 120 may be a global network, such as the Internet or other publicly accessible network. Various elements of the network 120 may be interconnected by a wide area network, a local area network, an Intranet, and/or other private network, which may not be accessible by the general public. Thus, the communication network 120 may represent a combination of public and private networks or a virtual private network (VPN). The network 120 may be a wireless network, a wireline network, or may be a combination of both wireless and wireline networks. The client devices 102, 105, 110 may represent wired and/or wireless devices that include one or more applications that use copies of data that may be extracted from the database 125. In addition, these client devices 102, 105, 110 may also include one or more applications that allow a user to interact and perform transactions with the database 125 via the host database system server 115. The client devices or terminals 102, 105, 110 may be connected directly to the host database management system server 115 without going through the network 120 in other embodiments of the inventive subject matter. It will be appreciated that in accordance with various embodiments of the inventive subject matter, the host database system management server 115 may be implemented as a single server, separate servers, or a network of servers either co-located in a server farm, for example, or located in different geographic regions.

As shown in FIG. 1, some embodiments according to the inventive subject matter can operate in a logically separated client side/server side-computing environment, sometimes referred to hereinafter as a client/server environment. The client/server environment is a computational architecture that involves a client process (i.e., client devices 102, 105 and 110) requesting service from a server process (i.e., host database management system server 115). In general, the client/server environment maintains a distinction between processes, although client and server processes may operate on different machines or on the same machine. Accordingly, the client and server sides of the client/server environment are referred to as being logically separated. Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

The clients and servers can communicate using a standard communications mode, such as Hypertext Transport Protocol (HTTP), SOAP, XML-RPC, and/or WSDL. According to the HTTP request-response communications model, HTTP requests are sent from the client to the server and HTTP responses are sent from the server to the client in response to an HTTP request. In operation, the server waits for a client to open a connection and to request information, such as a Web page. In response, the server sends a copy of the requested information to the client, closes the connection to the client, and waits for the next connection. It will be understood that the server can respond to requests from more than one client.

Although FIG. 1 illustrates an exemplary communication network including a database management system server for extracting data from a database in a user selected format, it will be understood that embodiments of the inventive subject matter are not limited to such configurations, but are intended to encompass any configuration capable of carrying out the operations described herein.

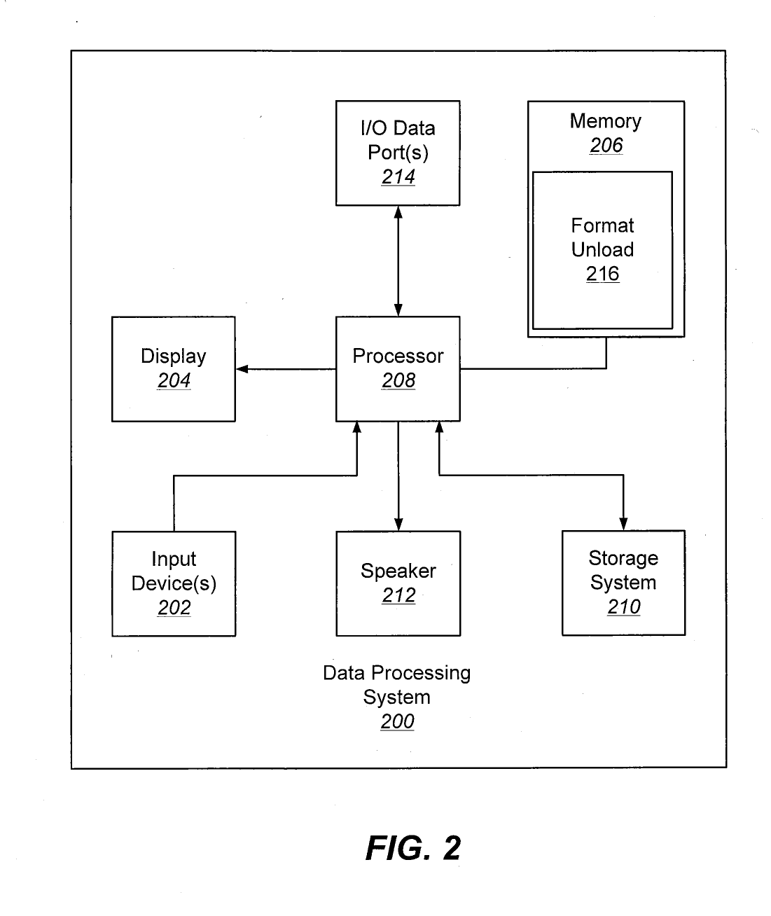

Referring now to FIG. 2, a data processing system 200 that may be used to implement the database management system server 115 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a format unload module 216 that may provide functionality that may include, but is not limited to, extracting data from a database in a user selected format in accordance with some embodiments of the inventive subject matter.

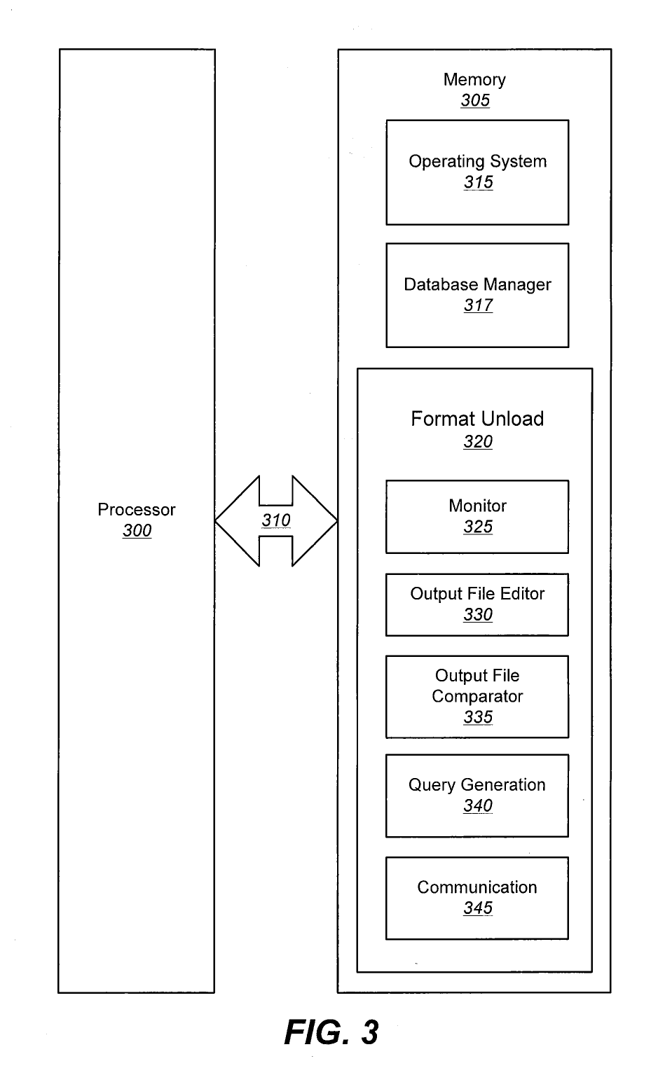

FIG. 3 illustrates a processor 300 and memory 305 that may be used in embodiments of data processing systems, such as the database management system server 115 of FIG. 1 and the data processing system 200 of FIG. 2, respectively, for extracting data from a database in a user selected format in accordance with some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for extracting data from a database in a user selected format in accordance with some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain three or more categories of software and/or data: an operating system 315, a database manager 317, and a format unload module 320. In particular, the operating system 315 may manage the data processing system's software and/or hardware resources and may coordinate execution of programs by the processor 300. The database manager 316 may comprise the database management system (DBMS) software, which is used to facilitate the definition, creation, querying, update, and administration of a database. The format unload module 320 may comprise a monitor module 325, an output file editor module 330, an output file comparator module 335, a query generation module 340, and a communication module 345.

The monitor module 325 may be configured to detect a first query for extracting a copy of data from a database. For example, for a DB2 database, the monitor module 325 may detect the invocation of the UNLOAD utility. In some embodiments, the monitor module 325 may intercept the query and generated a modified first query to obtain fewer records from the database than the original query was designed to obtain. The modified first query may be designed to extract a number of records that is sufficient for a user review the formats associated with the various data fields and make any desired changes. These format changes may be based, for example, on data formats used in an application that runs on another client system and/or client device. By modifying the first query to reduce the number of records extracted, both processor time and memory usage may be reduced. Specifically, the amount of memory consumed by a relation obtained based on the modified first query may be less than the amount of memory consumed by a relation obtained based on the first query without modification. The monitor module 325 may be further configured to detect when a relation is generated based on the original first query or the modified first query. This relation may be provided as an input to the output file editor module 330.

The output file editor module 330 may be configured to provide a visual interface of the first relation generated from the query or modified query of the database to allow a user to change the formats for one or more of the fields in the records to desired formats. In accordance with some embodiments, the data formats associated with the fields may include, but are not limited to, data formats, integer formats, numerical sign formats, and time formats. In general, a user may change the format associated with a field for any type of format that may be expressed in multiple ways. The format(s) associated with one or more fields may be changed so as to be compatible, for example, with a client application running on another system or device.

The output file comparator module 335 may be configured to determine what format changes a user has made to the first relation using the output file editor module 330. In some embodiments, the output file editor 330 may maintain two different files: a first file corresponding to the original first relation generated by the query or modified query of the database and a second file corresponding to a modified version of the original first relation after a user has made changes to the format(s) of one or more fields. The output file comparator module 335 may compare these two files to determine the format changes made by the user. In other embodiments, the output file comparator module 335 may cooperate with the output file editor 330 to determine the format changes made by the user as the user makes the changes without the need to maintain two different files and perform a file comparison. The output file comparator module 335 may be configured to remove the original first relation generated by the first query or modified first query and, if applicable, the modified version of the original first relation containing the user's format changes once the output file comparator module 335 has determined what format changes have been made to reduce the impact of these files on memory availability.

The query generation module 340 may be configured to generate a second query for extracting data from the database based on the format changes determined by the output file comparator module 335. The second query may have the appropriate syntax, options, and the like to be used in a query or command line so that the relation that is extracted from the database has fields with associated formats that reflect the formatting changes made by the user using the output file editor 330. The second query may be performed on the database to extract a second relation, i.e., without artificially limiting the number of records retrieved as the user's field format preferences have been incorporated into the second query.

The communication module 345 may be configured to communicate the second relation including records having one or more fields with formats based on user input received through the output file editor 330 to one or more systems or devices for processing by an application thereon. The field format changes made by the user may be designed to ensure that the second relation is compatible with a client application running on another system or device.

Although FIG. 3 illustrates hardware/software architectures that may be used in data processing systems, such as the database management system server 115 of FIG. 1 and the data processing system 200 of FIG. 2, respectively, for extracting data from a database in a user selected format in accordance with some embodiments of the inventive subject matter, it will be understood that the present invention is not limited to such a configuration but is intended to encompass any configuration capable of carrying out operations described herein.

Computer program code for carrying out operations of data processing systems discussed above with respect to FIGS. 1-3 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the database management system server 115 of FIG. 1 and the data processing system 200 of FIG. 2, and the hardware/software architecture of FIG. 3, may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

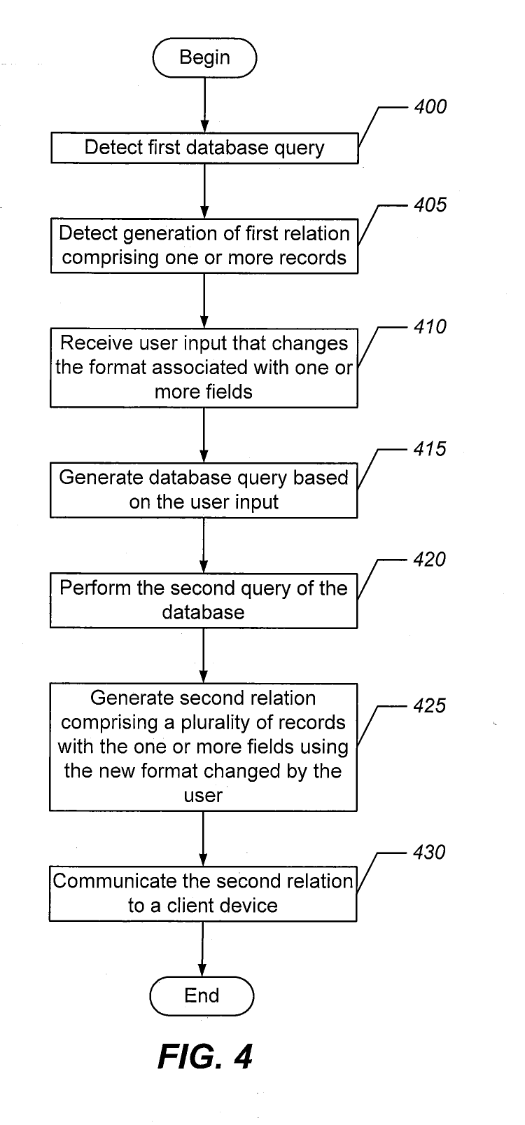

The data processing apparatus of FIGS. 1-3 may be used to facilitate the extraction of data from a database in a user selected format according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 206 coupled to the processor 208 and the memory 305 coupled to the processor 300 include computer readable program code that, when executed by the respective processors, causes the respective processors to perform operations including one or more of the operations described herein with respect to FIG. 4.

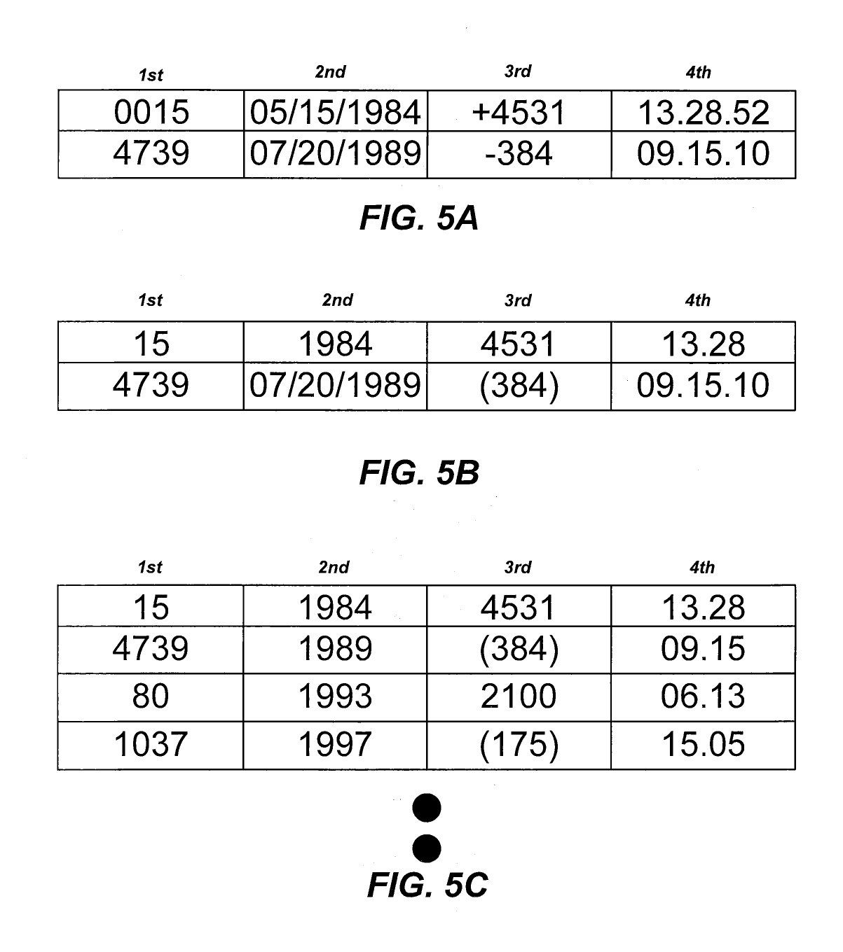

FIG. 4 is a flowchart that illustrates operations for extracting data from a database in a user selected format in accordance with some embodiments of the inventive subject matter. Operations begin at block 400 where the monitor module 325 detects a first query for extracting a copy of data from a database, such as an invocation of the UNLOAD utility for a DB2 database. In some embodiments, the monitor module 325 may intercept and modify the first query so as to reduce the number of records extracted in a relation to a number sufficient to allow a user to make any desired format changes for one or more fields in the records. This may be particularly beneficial when the first query is constructed to extract a very large amount of data that may consume both a relatively large amount of processor time to perform the extraction as well as memory resources to hold the file containing the extracted relation. The monitor module 325 may detect the generation of a first relation based on the first query or the modified first query at block 405. The first relation comprises one or more records with each record having a plurality of fields. FIG. 5A illustrates an example of the first relation extracted based on a modified first query in which two records are obtained. Each record includes four fields, first, second, third, and fourth with each field having an associated format. The format of first field is a four-digit integer format where leading zeros are used for integers that aren't expressed using four digits. The format of the second field is a date format. The format of the third field is a signed integer format. And the format of the fourth field is a time format.

Operations continue at block 410 where the output file editor module 330 receives user input to change the format of one or more fields of the records of the first relation. FIG. 5B illustrates an example of a user changing the format of various fields in the records of FIG. 5A. As shown in FIG. 5B, the user has changed the format of the first field to remove leading zeros placed in front of integers that are not expressed as four digits (0015 becomes 15). The user has changed the format of the second field to only include the year and to remove the month and date indications (05/15/1984 becomes 1984). The user has changed the format of the third field to eliminate use of the + sign to indicate a positive number and to use parentheses to indicate a negative number. And the use has changed the format of the fourth field to remove the tenths and hundredths second portion of the timestamp (13.28.52) becomes (13.28). The output file comparator module 335 may, according to some embodiments of the inventive concept, the use need only change the format for a field in one record and the output file comparator module 335 may understand that the changed format applies to that field for all records in the relation. The output file comparator module 335 determines what formats the user has changed and provides this information to the query generation module 340. At block 415, the query generation module 340 generates a second query for extracting data from the database based on the format changes determined by the output file comparator module 335. The second query may have the appropriate syntax, options, and the like to be used in a query or command line so that the relation that is extracted from the database has fields with associated formats that reflect the formatting changes made by the user using the output file editor 330. The query generation module 340 performs the second query on the database at block 420 to extract a second relation at block 425. FIG. 5C illustrates an example of the second relation that is generated based on a query constructed based on the field format changes shown in FIG. 5B. As shown in FIG. 5C, the number of records in the second relation are not artificially limited as the user's field format preferences have been incorporated into the second query. Specifically, the leading zeros have been eliminated for integers in the first field, the month and day information has been eliminated for dates in the second field, the + sign has been eliminated and parentheses are used to indicate a negative number for integers in the third field, and the tenth and hundredth second fraction information has been truncated for timestamps in the fourth field. Returning to FIG. 4, at block 430, the communication module 345 may communicate the second relation, such as the second relation illustrated in FIG. 5C, to another system or device for processing by a client application. The format changes for the various fields of the records in the relation may be based on formats used in the client application.

Embodiments of the inventive subject matter may provide a mechanism for a user to extract data from a database for use, for example, by another application on a client device or system, which may have specific data format requirements, without needing expertise in writing command lines or queries to extract the data in the desired formats. This may provide reductions in both processor time spent in performing data extractions from a database that return errant formats and the memory consumed in storing such data extractions if they are not timely deleted thereby improving the operation of the host system. Moreover, by extracting the data from the database in the desired format(s) through the query of the database, both user and processor time may be saved (on a host system and/or a receiving client device/system) in correcting the format(s) in the extracted relation relative to alternatives approaches, such as processing the extracted relation to change the formats of one or more fields using an editor, tool, or other mechanism.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Peri, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
performing by a host system processor:
detecting a first query of a database;
detecting a first relation that is generated responsive to the first query of the database, the first relation comprising a record having a plurality of fields, each of the plurality of fields having a format associated therewith;
receiving user input that changes the format associated with one of the plurality of fields from a first format to a second format;
generating a second query for the database based on the user input;
performing the second query of the database;
generating a second relation responsive to the second query of the database, the second relation comprising a plurality of records, each of the plurality of records comprising the plurality of fields; and
communicating the second relation to a client device application;
wherein the one of the plurality of fields in each of the plurality of records has the second format.

2. The method of claim 1, wherein detecting the first query of the database comprises:
modifying the first query of the database to generate a modified first query for the database; and
performing the modified first query of the database;
wherein the first relation is generated responsive to the modified first query of the database.

3. The method of claim 2, wherein the first relation comprises a first plurality of records and the second relation comprises a second plurality of records, a number of the second plurality of records being greater than a number of the first plurality of records.

4. The method of claim 1, further comprising:
generating a modified first relation responsive to receiving the user input, the modified first relation comprising a modified record having the plurality of fields with the one of the plurality of fields having the second format associated therewith.

5. The method of claim 4, wherein generating the second query for the database comprises:
comparing the modified first relation with the first relation;
determining a difference between the modified first relation and the first relation; and
generating the second query for the database based on the difference between the modified first relation and the first relation.

6. The method of claim 1, wherein the first and second formats are one of date formats, integer formats, numerical sign formats, and time formats.

7. The method of claim 1, wherein the database is a relational database.

8. The method of claim 7, wherein the relational database is a DB2 database.

9. The method of claim 1, wherein the second format is used in the client device application.

10. A system, comprising:
a processor; and
a memory coupled to the processor and comprising computer readable program code embodied in the memory that is executable by the processor to perform:
detecting a first query of a database;
modifying the first query of the database to generate a modified first query for the database;
performing the modified first query of the database;
detecting a first relation that is generated responsive to the modified first query of the database, the first relation comprising a record having a plurality of fields, each of the plurality of fields having a format associated therewith;
receiving user input that changes the format associated with one of the plurality of fields from a first format to a second format, the second format being used in a client device application;
generating a second query for the database based on the user input;
performing the second query of the database;
generating a second relation responsive to the second query of the database, the second relation comprising a plurality of records, each of the plurality of records comprising the plurality of fields; and
communicating the second relation to the client device application;
wherein the one of the plurality of fields in each of the plurality of records has the second format.

11. The system of claim 10, wherein the first relation comprises a first plurality of records and the second relation comprises a second plurality of records, a number of the second plurality of records being greater than a number of the first plurality of records.

12. The system of claim 10, further comprising:
generating a modified first relation responsive to receiving the user input, the modified first relation comprising a modified record having the plurality of fields with the one of the plurality of fields having the second format associated therewith.

13. The system of claim 12, wherein generating the second query for the database comprises:
comparing the modified first relation with the first relation;
determining a difference between the modified first relation and the first relation; and
generating the second query for the database based on the difference between the modified first relation and the first relation.

14. The system of claim 10, wherein the first and second formats are one of date formats, integer formats, numerical sign formats, and time formats.

15. A computer program product comprising:
a tangible computer readable storage medium comprising computer readable program code embodied in the medium that is executable by a processor to perform:
detecting a first query of a database;
detecting a first relation that is generated responsive to the first query of the database, the first relation comprising a record having a plurality of fields, each of the plurality of fields having a format associated therewith;
receiving user input that changes the format associated with one of the plurality of fields from a first format to a second format;
generating a second query for the database based on the user input;
performing the second query of the database;
generating a second relation responsive to the second query of the database, the second relation comprising a plurality of records, each of the plurality of records comprising the plurality of fields; and
communicating the second relation to a client device application;
wherein the one of the plurality of fields in each of the plurality of records has the second format; and
wherein the first relation consumes less memory than the second relation.

16. The method of claim 15, wherein detecting the first query of the database comprises:
modifying the first query of the database to generate a modified first query for the database; and
performing the modified first query of the database;
wherein the first relation is generated responsive to the modified first query of the database.

17. The method of claim 16, wherein the first relation comprises a first plurality of records and the second relation comprises a second plurality of records, a number of the second plurality of records being greater than a number of the first plurality of records.

18. The method of claim 15, further comprising:
generating a modified first relation responsive to receiving the user input, the modified first relation comprising a modified record having the plurality of fields with the one of the plurality of fields having the second format associated therewith.

19. The method of claim 18, wherein generating the second query for the database comprises:
comparing the modified first relation with the first relation;
determining a difference between the modified first relation and the first relation; and
generating the second query for the database based on the difference between the modified first relation and the first relation.

20. The method of claim 15, wherein the first and second formats are one of date formats, integer formats, numerical sign formats, and time formats; and
wherein the second format is used in the client device application.
